(19) United States
(12) Patent Application Publication
(10) Pub. No.: US 2007/0093735 A1
(43) Pub. Date: Apr. 26, 2007

(54) Backscratcher

(76) Inventor: Emiko Suzuki, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/580,031

(22) Filed: Oct. 13, 2006

(30) Foreign Application Priority Data
Oct. 21, 2005 (JP) JP2005-307635

(51) Int. Cl. A61H 7/00

(52) U.S. Cl. 601/137; 601/135

(57) ABSTRACT

A backscratcher which can be inserted into a space between clothes and the skin is capable of intensely scratching an itching area and has excellent usability. A backscratcher 10 has a shaft 12, a grip 11 provided at a base end of the shaft 12, a curved head potion 13 at a distal end of the shaft 12, and claws 14a and 14b branching off from a distal end of the head portion 13. The claws 14a and 14b have a substantially conical form, and base end portions thereof are integrally constructed with the head portion 13. Each tip end of the claws 14a and 14b is pointed to the extent that the end does not hurt the skin. On a base end of the grip 11 provided at the base end of the shaft 12, a hole for hooking 16 is formed. The backscratcher 10 is gripped with a hand on the grip 11 and moved with the two claws 14a and 14b at the distal end of the shaft 12 brought into contact with an itching area. Thus, the itching area can be intensely scratched with the plurality of the claws 14a and 14b.

### BACKGROUND OF THE INVENTION

1. Field of the Invention

The present invention relates to a backscratcher which is used for scratching a hard-to-reach body part such as the back and shoulder, or a portion that is covered with clothes and cannot be directly touched by hand.

2. Description of the Related Art

Conventionally, backscratchers generally used at home are mostly made of bamboo. Most are designed like folk handicraft having a similar design, with little emphasis or intentions toward better usability or function. Accordingly, such conventional backscratchers have rugged and rough configurations and thus are not comfortable to the touch. In addition, their flat and thin handles which are hard to grip firmly make it difficult to apply force when using. Another drawback is the difficulty in bringing the distal end for scratching the body into close contact with the skin. Moreover, these backscratchers do not provide a comfortable scratching effect to the body and hardly relieve the itching in actual use, which is likely to irritate the users.

Thus, some improvements in the above backscratchers have been made hitherto. For example, provided are a backscratcher having a curved plate-like scratching portion at a distal end of a shank (Unexamined Japanese Patent Publication No. H09-075412), a backscratcher having an elbow joint section and a hand joint section like a human arm (Unexamined Japanese Patent Publication No. H08-057009) and a backscratcher with a portion to touch the skin formed as a brush (Unexamined Japanese Utility Model Publication No. H06-074135). Furthermore, it has been suggested that a backscratcher has a scratching claw provided at a distal end of a curved handle forming a circular arc (U.S. Pat. No. Des. 312,145).

The above backscratchers disclosed in Unexamined Japanese Patent Publications Nos. H09-075412 and H08-057009 and Unexamined Japanese Utility Model Publication No. H06-074135 have better usability compared to the conventional backscratchers made of bamboo and provide satisfactory results when scratching an itching area. Nevertheless, these backscratchers have various problems. Specifically, the scratching portion of the backscratcher described in Unexamined Japanese Patent Publications No. H09-075412 provided at the distal end has the width of approximately 5 to 8 cm. Therefore, it is difficult to insert the backscratcher between clothes and skin if the space is narrow, which can hinder easy handling depending on the place to scratch. Also in Unexamined Japanese Patent Publication No. H08-057009, the end portion composed of the hand and finger sections is relatively large, raising the problem of difficulty in inserting into the gap between clothes and the skin as in the previous device.

The backscratcher disclosed in Unexamined Japanese Utility Model Publication No. H06-074135 has a structure in which a brush is used to rub an itching portion. Accordingly, the surface area to touch the skin is wide, and the force is hardly concentrated on the itching portion. In addition, since the brush portion has a relatively large dimension, the backscratcher is not easy to insert into the gap between clothes and the skin as in the above backscratchers.

In the backscratcher described in U.S. Pat. No. Des. 312,145, the handle is curved to form a large arc toward the distal end of the handle. Therefore, not only is it difficult to insert into the gap between clothes and the skin, but also hardly any force is concentrated on the target portion and the claw can slip away from the itching point because the curved portion of this backscratcher wobbles when moving on the itching area.

### SUMMARY OF THE INVENTION

A backscratcher of the present invention comprises a shaft, a grip provided at a base end of the shaft, a head portion provided at a distal end of the shaft and having a curved or bent form, and a plurality of claws formed at a distal end of the head portion.

### BRIEF DESCRIPTION OF THE DRAWINGS

In the accompanying drawings:

FIG. 1 is a side view illustrating a backscratcher of an embodiment of the present invention;

FIG. 2 is an enlarged perspective view illustrating a distal end portion of the backscratcher in FIG. 1;

FIG. 3 is a side view illustrating a backscratcher of another embodiment of the present invention; and

FIG. 4 is an enlarged perspective view illustrating a distal end portion of the backscratcher in FIG. 3.

### DETAILED DESCRIPTION OF THE PREFERRED EMBODIMENT

With reference to the accompanied drawings, embodiments of the present invention will be explained below.

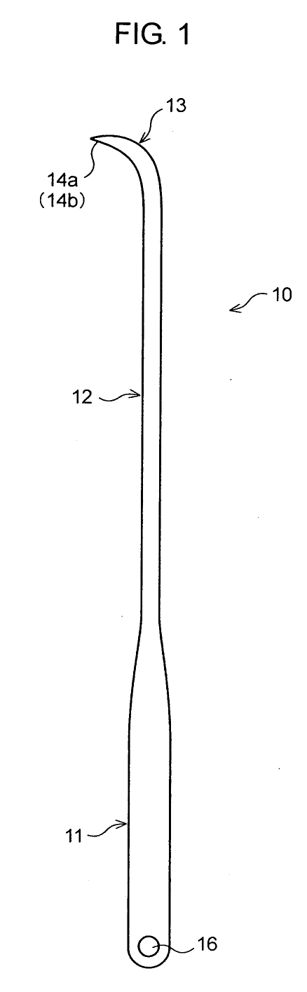

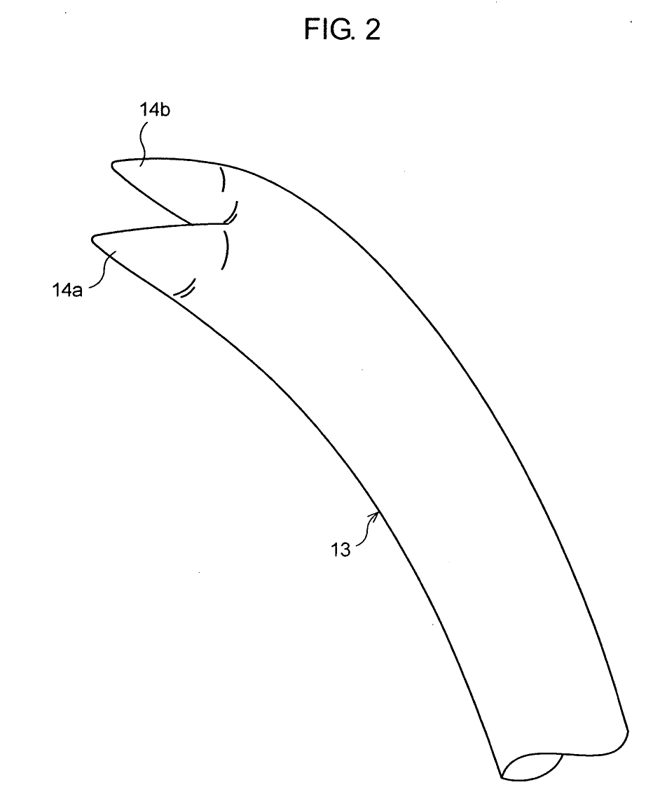

As illustrated in FIGS. 1 and 2, a backscratcher 10 of this embodiment has a linearly-formed shaft 12, a grip 11 provided at a base end of the shaft 12, a head portion 13 provided at a distal end of the shaft 12 and having a form curved substantially in a right angle, and claws 14a and 14b which branch off from the head portion 13 at a distal end of the head portion 13. Each of the claws 14a and 14b has a substantially conical form with a base end portion thereof integrally constructed with the head portion 13. Each tip end of the claws 14a and 14b is pointed to the extent that the end does not hurt the skin. On a base end of the grip 11 formed at the base end of the shaft 12, a hole for hooking 16 is provided.

The backscratcher 10 is manipulated in a similar manner to those of the conventional backscratchers. Namely, the backscratcher 10 is held with a hand on the grip 11 and moved with the tip ends of the two claws 14a and 14b at the distal end of the shaft 12 brought into contact with an itching area. Thus, the itching portion can be precisely and forcefully scratched with the plurality of the claws 14a and 14b to quickly relieve the itch. Accordingly, the backscratcher does not intensify irritation of the user due to the uncomfortable scratching effect in use as with conventional backscratchers.

The head portion 13 having the claws 14a and 14b is formed at the distal end of the linearly-formed shaft 12 to curve in a substantially right angle. The claws 14a and 14b extend toward a direction which is perpendicular to a longitudinal direction of the shaft 12. As a whole, the head portion 13 with the claws 14a and 14b has an extremely thin structure and a smooth surface. With these structures, the backscratcher can be easily inserted into a gap between clothes and the skin of the user generated by looseness and elasticity of the clothes such as a space between a sleeve and an arm, for example.

Additionally, the force exerted on the grip 11 transmits through the linearly-formed shaft 12 precisely to the claws 14a and 14b at the distal end of the shaft 12 via the head portion 13 which is curved with a right angle against the shaft 12, resulting in improved usability. The shaft 12, which has a linear form except for the head portion 13, does not sway when moved with the claws 14a and 14b brought into contact with the itching area. Thus, it is easy to concentrate the force onto the target area, and the claws 14a and 14b do not slip away from the itching point. Here, the number of the claws 14a and 14b is not limited to the number employed in this embodiment but may be optimally changed.

In the case of the backscratcher 10 of this embodiment, the head portion 13, which curvilinearly rises up, runs along any portion of the body to which the backscratcher 10 is applied so as to closely contact with the skin, and the claws 14a and 14b can precisely contact the itching point, thereby quickly relieving the itch. Furthermore, since the head portion 13 extends from the shaft 12 to curve in a right angle, the force loaded on the grip 11 is easily concentrated on the head portion 13 so that the head portion 13 can securely press the itching point with a relatively light force without slipping away from the itching point or moving around. In this manner, the backscratcher 10 can be used by a weak-handed person without effort.

The curved head portion 13 further enhances the usability because the backscratcher 10 keeps fitting along the body when the user holds the grip 11 with one hand to move the backscratcher 10 over his/her shoulder or scratches his/her waist while lying down. In actual use, the plurality of the claws 14a and 14b provided on the backscratcher 10 can realize delicate and effective scratching as much as the scratching effect of the user's own finger nails and quickly relieve the itching. The claws 14a and 14b in this embodiment have a substantially conical form; however, they may have a pyramid form instead.

The grip 11 which is thicker than the distal end portion of the shaft 12 and has a proper size and shape for one-handed operation can be securely gripped with one hand. Therefore, the backscratcher 10 can be stably held during use and comfortably manipulated. When the backscratcher 10 is not used, the hole for hooking 16 formed on the base end of the grip 11 can be used for hanging and holding the backscratcher 10 on a hook on a wall or the like.

The material used for forming the shaft 12, the grip 11, the head portion 13 and the claws 14a and 14b of the backscratcher 10 is not particularly limited. If, however, synthetic resin is used, for example, the backscratcher 10 with lighter weight and various designs can be obtained. Additionally, the synthetic resin material allows mass production by integral molding by means of injection molding, which realizes cost reduction.

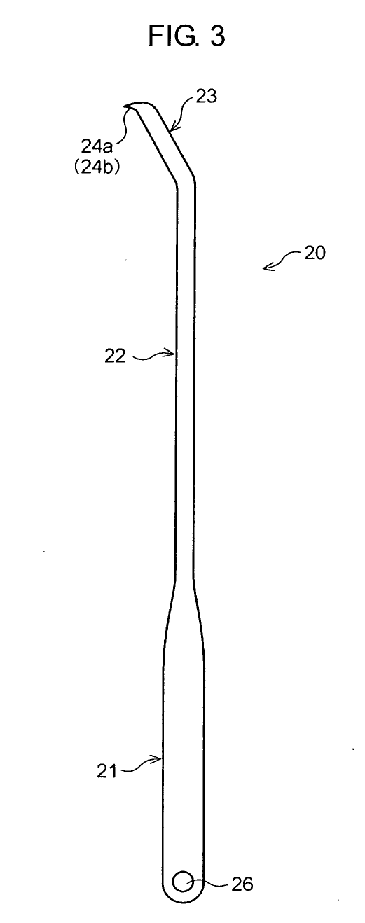

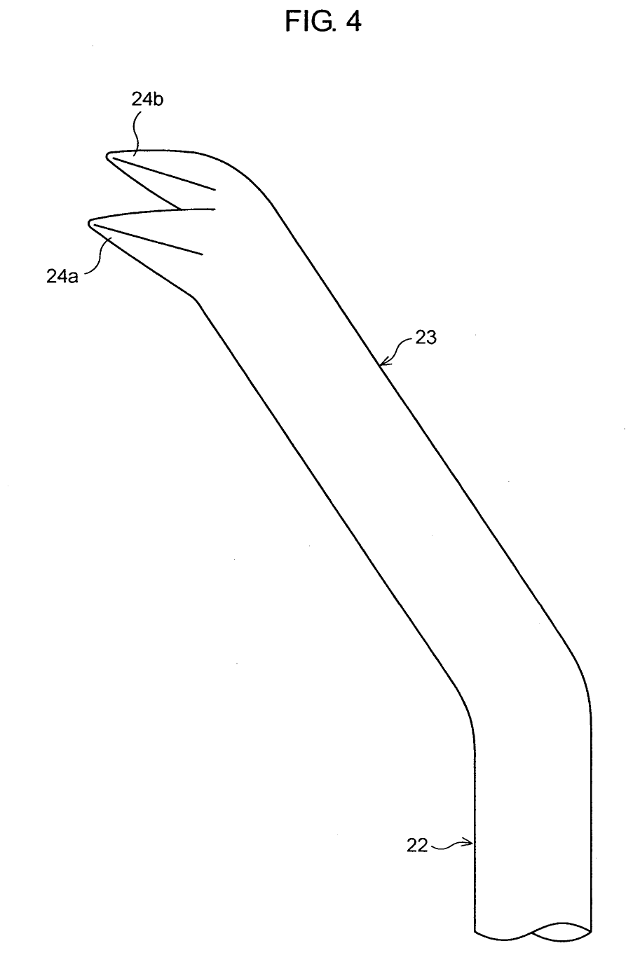

Next, another embodiment will be explained with reference to FIGS. 3 and 4. A backscratcher 20 which is another embodiment of the present invention has a linearly-formed shaft 22, a grip 21 provided at a base end of the shaft 22, a head portion 23 provided at a distal end of the shaft 22 and having a bent form, and claws 24a and 24b which branch off from the head portion 23 at a distal end of the head portion 23. Each of the claws 24a and 24b has a substantially quadrangular pyramid form with a base end portion thereof integrally constructed with the head portion 23. Each tip end of the claws 24a and 24b is pointed to the extent that the end does not hurt the skin. On a base end of the grip 21 formed at the base end of the shaft 22, a hole for hooking 26 is provided.

The backscratcher 20 is manipulated in a similar manner to that of the above-described backscratcher 10. Namely, the backscratcher 20 is held with a hand on the grip 21 and moved with the tip ends of the two claws 24a and 24b at the distal end of the shaft 22 brought into contact with an itching area. Thus, the itching portion can be precisely and forcefully scratched with the tip ends of the plurality of the claws 24a and 24b to quickly relieve the itch. Accordingly, the backscratcher does not intensify irritation of the user due to the uncomfortable scratching effect in use as with conventional backscratchers. Other functions and advantages are the same as those with the backscratcher 10 described above.

In the backscratcher 20, the head portion 23 is inclined at an angle of approximately 30 degrees with respect to the linearly-formed shaft 22. However, the angle of inclination is not limited to 30 degrees but may be selected in a range from 30 to 60 degrees.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. A backscratcher comprising:
a shaft,
a grip provided at a base end of the shaft,
a head portion provided at a distal end of the shaft and having a curved form, and
a plurality of claws formed at a distal end of the head portion.

2. A backscratcher comprising:
a shaft,
a grip provided at a base end of the shaft,
a head portion provided at a distal end of the shaft and having a bent form, and
a plurality of claws formed at a distal end of the head portion.
